(19) United States
(12) Patent Application Publication
(10) Pub. No.: US 2002/0020072 A1
(43) Pub. Date: Feb. 21, 2002

(54) Universal non-electronic multi-sectional gradient meter and inclinometer and method of use

(76) Inventors: Hans U. Roth, Kradolf (CH); Martin Sachsenmaier, Erlen (CH)

Correspondence Address: Pandiscio & Pandiscio, 470 Totten Pond Road, Waltham, MA, 02451-1914, US

(21) Appl. No.: 09/741,935

(22) Filed: Dec. 20, 2000

Related U.S. Application Data
(60) Provisional application No. 60/172,766, filed on Dec. 20, 1999.

(51) Int. Cl. G01C 9/24

(52) U.S. Cl. 33/389

(57) ABSTRACT

A novel apparatus and method for use in measuring surface slope is disclosed. In a preferred embodiment, the measurement apparatus includes a fluid case having an arch of flat segments forming a sloped ceiling. In another preferred embodiment, a smooth curve, instead of a series of flat segments, is formed by reducing the length, and increasing the number, of the constant slope flat segments. A method for measuring the slope of a surface includes providing a measurement apparatus, placing the measurement apparatus adjacent the surface and reading an indicator corresponding to the slope of the surface.

### FIELD OF THE INVENTION

This invention relates to measurement hand tools in general. More particularly, this invention relates to multi-sectional measurement tools used to non-electronically measure surface gradient and inclination.

### BACKGROUND OF THE INVENTION

Tools for measuring surface gradient or surface inclination are well known in the art. For example, on construction sites, and in other situations, accurate and precise measurement must be considered for the gradient and the inclination of a surface. Water-level instrumentation and electronic instrumentation are currently used to indicate whether or not a particular surface is level.

Water-level instrumentation, as currently disclosed in the prior art, generally does not accurately indicate the percentage of gradient and amount of inclination for a non-level surface.

Electronic instrumentation is used in some applications for measuring the gradient and inclination of surfaces. Other applications are in extreme condition environments, such as construction sites, and the use of electronic instrumentation is not practical due to various factors. These factors include environmental factors, such as shock sensitivity, and the replacement cost for broken or damaged electronic instrumentation.

The foregoing demonstrates the need for novel instrumentation to measure surface gradient and surface inclination. Ideally, the measurement instrumentation should be highly accurate and precise for measuring surface gradient and surface inclination. The measurement instrumentation should also be unaffected by most environmental factors. Furthermore, the measurement instrumentation should be inexpensive to manufacture.

### SUMMARY OF THE INVENTION

These and other objects are addressed by the present invention, which comprises a novel apparatus and method for use in measuring surface slope, including gradient and inclination, in such places as a construction site. The present invention provides a universal non-electronic multi-sectional gradient meter and inclinometer.

The measurement apparatus includes a fluid case containing a fluid and an indicator, calibrated markings on the fluid case corresponding to the indicator, and a sloped ceiling within the fluid case.

In a preferred embodiment, the sloped ceiling includes several portions forming an arch and each portion has a constant slope. From a portion corresponding to zero slope, the other portions slope downwardly from the portion corresponding to zero slope toward each end of the fluid case, respectively. The portions also have a progressively increasing slope from the zero slope portion to each end, respectively. In this configuration, an arch of flat segments is formed in the profile view of fluid case's ceiling.

In another preferred embodiment, the sloped ceiling includes several portions forming an arch, each portion having a constant slope along its length. From one end of the fluid case and a portion corresponding to zero slope, each of the other portions slope away from the zero slope portion toward the other end of the fluid case and have progressively increasing slopes. As such, the zero slope portion is located in one end of the fluid case and an arch of flat segments is formed in the fluid case's ceiling.

In another preferred embodiment, the portions in the slope ceiling are shortened, and additional portions are added, to form a smooth curve instead of a series of flat segments.

In still another preferred embodiment, a smooth curve, instead of a series of flat segments, is formed in the slope ceiling by reducing the length, and by increasing the number, of the constant slope portions.

A method for measuring the slope of a surface includes providing a measurement apparatus, placing the measurement apparatus, and reading an indicator corresponding to the slope of the surface.

### BRIEF DESCRIPTION OF THE DRAWINGS

These and other features of the present invention will be more fully disclosed or rendered obvious by the following detailed description of the invention, which is to be considered in conjunction with the accompanying drawings wherein like numbers refer to like parts and further wherein:

FIG. 1 is a side elevational view of a measurement instrument for determining the slope of a surface;

FIG. 2 is a top plan view of the measurement instrument of FIG. 1;

FIG. 3 is an end elevational view of the measurement instrument of FIG. 1;

FIG. 4 is a side cross-sectional view of the measurement instrument of FIG. 1;

FIG. 5 is an end cross-sectional view of the measurement instrument of FIG. 1;

FIG. 6 is a side elevational view of a measurement instrument for determining the slope of a surface;

FIG. 7 is a top plan view of the measurement instrument of FIG. 6;

FIG. 8 is a cross-sectional view of the measurement instrument of FIG. 6;

FIG. 9 is a side elevational view of the measurement instrument of FIG. 1 in attachment with a prior art level instrument;

FIG. 10 is a top plan view of the measurement instrument and prior art level of FIG. 9;

FIG. 11 is an end view of the measurement instrument and prior art level of FIG. 9;

FIG. 12 is a side elevational view of the measurement instrument of FIG. 1 disposed within a prior art level;

FIG. 13 is a top plan view of the apparatus of FIG. 12;

FIG. 14 is a cross-sectional view of the apparatus of FIG. 12;

FIG. 15 is a side elevational view of the measurement instrument of FIG. 6 in attachment with a prior art level instrument;

FIG. 16 is a top plan view of the measurement instrument and prior art level of FIG. 15; and

FIG. 17 is a schematic of a ceiling configuration of the measurement instrument of FIG. 1 in which regions X, Y, Z each have a constant slope of increasing magnitude to one another from the instrument's level center toward each of the ends, respectively.

### DETAILED DESCRIPTION OF THE INVENTION

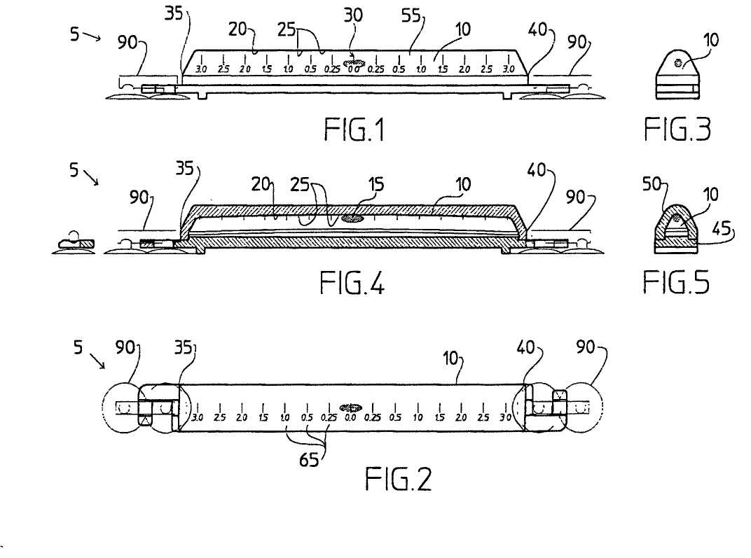

Referring to FIGS. 1-16, a measurement apparatus 5 is shown for measuring the gradient of inclination of a surface (not shown). Measurement apparatus 5 includes a fluid case 10 having an indicator 15, such as an air bubble, and a ceiling 20. Indicator 15 reacts to changes in the elevation of the ceiling 20 as measurement apparatus 5 is disposed on a surface. Ceiling 20 is formed having multiple sections 25. From a portion 30 of ceiling 20 in which indicator 15 signals that apparatus 5 is on a zero slope, or a level surface, sections 25 slope progressively downward toward first end 35 and toward second end 40, respectively. In one form of the invention, each of the sections 25 has a constant slope along its own length. In another form of the invention, sections 25 are integral to one another so as to form a curved surface.

Still looking at FIGS. 1-16, in a preferred embodiment of the invention, liquid case 10 is configured with a wider cross-sectional width along a bottom surface 45 and a narrower cross-sectional width along an upper portion 50 adjacent ceiling 20. This configuration is advantageous in that the motion and display of indicator 15 is amplified to indicate the gradient or the inclination of a portion of the surface measured by apparatus 5. Apparatus 5 uses a fluid composition 55 similar to, or the same as, a standard water-level.

Now looking at FIGS. 1-5, apparatus 5 is shown with measurement units 65 in the configuration of a gradient meter. In this embodiment, measurement units 65 include 0.25, 0.5, 1.0, 2.0, 2.5, 3.0 percentage of elevation deviation from exact level 0.0 towards each end 35 and 40, respectively. Apparatus 5 may also include other measurement units 65.

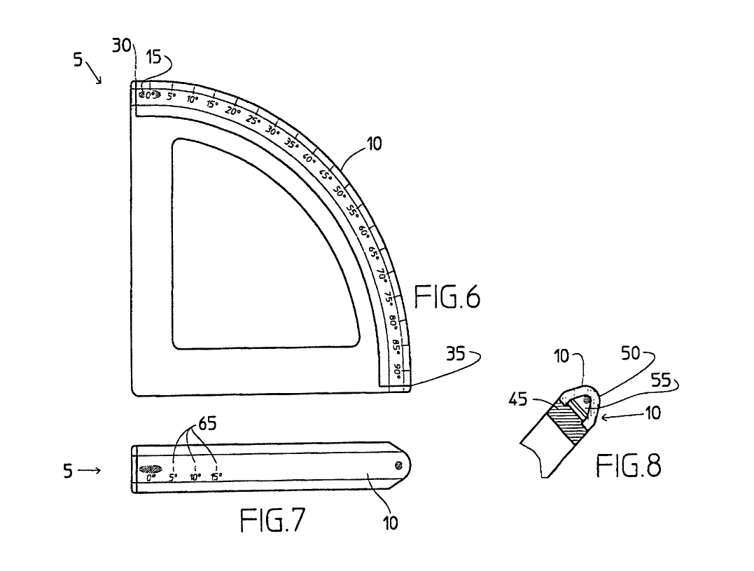

Now looking at FIGS. 6-8, another preferred embodiment of apparatus 5 is shown with measurement units 65 in the configuration of an inclinometer. In this embodiment, measurement units 65 include 0°-90° indications in units of 5°.

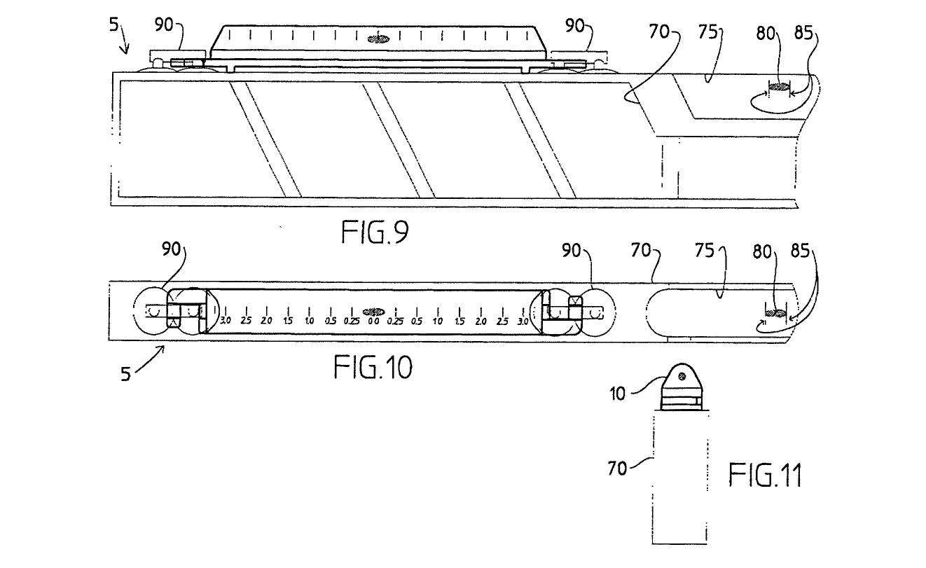

Referring now to FIGS. 9-17, in still another preferred embodiment, apparatus 5 is shown in several configurations with a standard level device 70. In FIGS. 9-11, apparatus 5 is detachably attached to the top of standard level device 70. Standard level device 70 has a prior art fluid filled chamber 75 including a bubble 80 to indicate zero slope of a surface when bubble 80 is between lines 85. In this configuration, apparatus 5 is attached to standard level device 70 using attachment means 90. Attachment means 90 include, but are not limited to, suction cups and other temporary or permanent mounting means generally known. An aftermarket kit contains apparatus 5 and attachment means 90 to retrofit existing standard level devices.

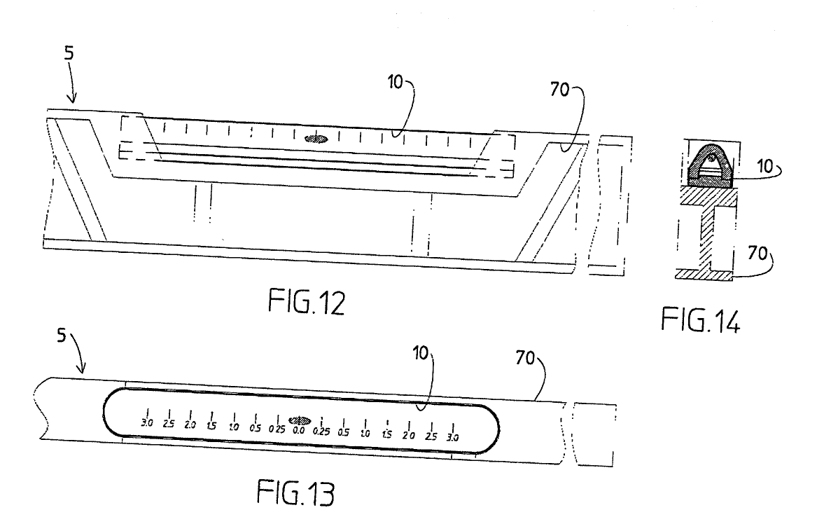

Now looking at FIGS. 12-14, apparatus 5 is shown contained within a standard level device 70. In a preferred embodiment, standard level device 70 and apparatus 5 are manufactured together for use as shown. In another preferred embodiment, standard level device 70 is manufactured specifically such that apparatus 5 may be replaced if broken or defective. In a third preferred embodiment, apparatus 5 is configured to retrofit standard level device 70, which originally contains a prior art level fluid filled chamber 75.

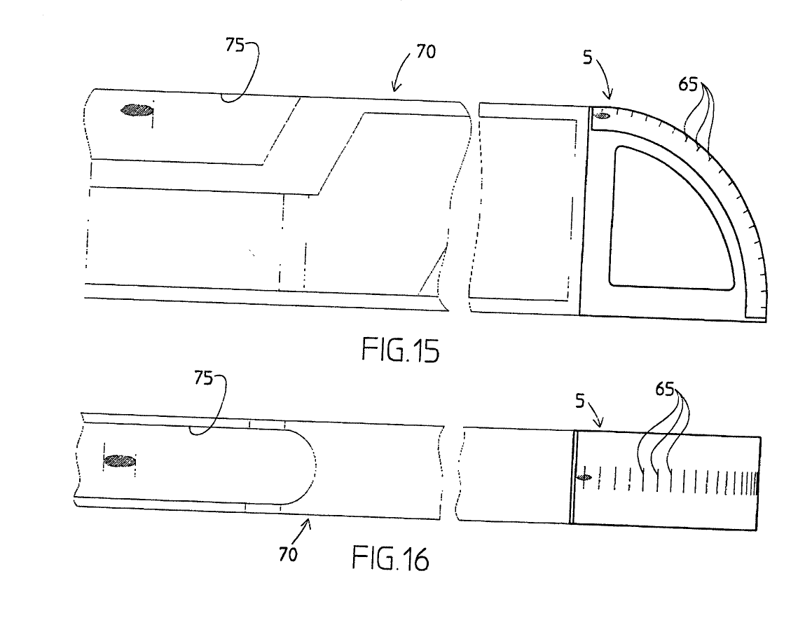

Now referring to FIGS. 15 and 16, a preferred embodiment of apparatus 5 is shown in configuration with standard level device 70. Apparatus 5 is mounted at an end of level 70 such that the inclination is indicated by measurement units 65 from above and to the side. This present embodiment is similar to an above embodiment, as shown in FIGS. 6-8, in which apparatus 5 is a standalone unit. In the present embodiment, apparatus 5 may be sold in a kit with attachment means (not shown) for attachment to an existing level 70.

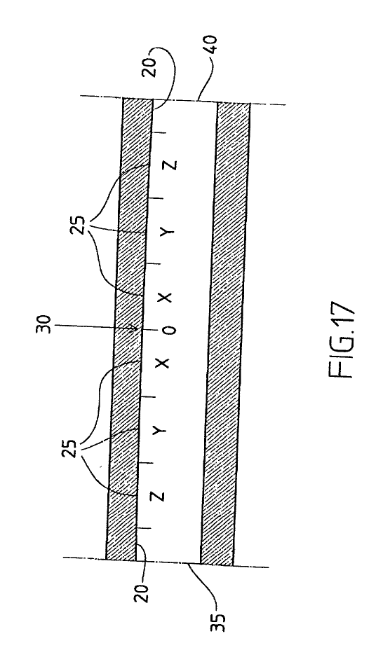

Looking now at FIG. 17, three sections 25, including regions X, Y, Z, are each shown on both sides of zero slope portion 30. Regions X, Y, Z, on each side of portion 30, each slope progressively downward from portion 30 toward first end 35 and second end 40, respectively. Each portion is shown with a constant slope over each region X, Y, Z. However, as discussed above, regions X, Y, Z may be configured to have an increasing slope, without any constant slope regions, over the expanse from portion 30 toward first end 35 and second end 40. This configuration is demonstrated in FIG. 6. A configuration between these two embodiments is accomplished by successively reducing the length of regions X, Y, Z and adding additional sections 25.

It should also be appreciated that in FIG. 17, zero slope portion 30 is shown as the apex of two adjacent sloped sections 25 (i.e. regions X); however, if desired, zero slope portion 30 could also comprise a longitudinally extending surface, of zero slope, extending between adjacent sloped sections 25 (i.e., regions X).

In a preferred embodiment of the invention (not shown), a single unit is disclosed with a first apparatus 5 having a first set of measurement units 65 and a second apparatus 5 having a second set of measurement units 65. In one configuration, first and second measurement units allow simultaneous measurement on a single surface of its gradient, as a percentage of elevation deviation, and of its inclination, as measured in degrees. Alternatively, first and second measurement units are configured with differing scales. As such, precise measurements can be taken over multiple ranges, rather than one narrow range.

The present invention is not limited to the foregoing specific embodiments, but also encompasses all improvements and substitutions within the scope of the claims.

What is claimed is:

1. A measurement apparatus for measuring the slope of a surface, the apparatus comprising:
a fluid case having a wall forming a closed container, the fluid case having an upper wall surface, a lower wall surface, a first end, a second end, and a longitudinal axis from the first end to the second end of the fluid case;
a fluid contained within the fluid case, the fluid having a given density;
an indicator contained within the fluid case, the indicator having a density less than the given density of the fluid;
calibrated markings on the fluid case corresponding to the indicator at the positioned slope of the measurement apparatus; and
a sloped ceiling formed in the upper wall surface along the longitudinal axis of the fluid case, a first portion of the ceiling having no slope relative to a flat reference surface, the first portion corresponding to a zero-point of the calibrated markings, and a second portion of the ceiling between the first portion and the first end, the second portion having a constant slope, downwardly, toward the first end.

2. The measurement apparatus of claim 1 wherein the sloped ceiling has a third portion between the first portion and the second end, the third portion having a constant slope, downwardly, toward the second end.

3. The measurement apparatus of claim 1 further comprising a sloped ceiling having a plurality of second portions, each of the second portions having a constant slope, and each of the second portions increasing in slope from the first portion to the first end.

4. The measurement apparatus of claim 2 further comprising a slope ceiling having a plurality of second portions and third portions, the second portions and the third portions each having a constant slope, respectively, and the second portions and the third portions each increasing in slope from the first portion to the first end and the second end, respectively.

5. The measurement apparatus of claim 3 wherein the first portion and the plurality of second portions are infinitely small and form a curved surface.

6. The measurement apparatus of claim 4 wherein the first portion, the plurality of second portions, and the plurality of third portions are infinitely small and form a curved surface.

7. The measurement apparatus of claim 1 wherein the calibrated markings on the fluid case is percentage of elevation.

8. The measurement apparatus of claim 7 wherein the apparatus is a gradient meter.

9. The measurement apparatus of claim 1 wherein the calibrated markings on the fluid case is degree of inclination.

10. The measurement apparatus of claim 1 wherein the apparatus is an inclinometer.

11. The measurement apparatus of claim 1 wherein the indicator being contained within the fluid within the fluid case is an air bubble formed by the fluid.

12. The measurement apparatus of claim 1 wherein the indicator being contained within the fluid within the fluid case is another fluid.

13. The measurement apparatus of claim 1 wherein the indicator being contained within the fluid within the fluid case is a solid object.

14. The measurement apparatus of claim 1 wherein the lower wall surface of the fluid case forms a base having a given wide cross-sectional width orthogonal to the longitudinal axis, and the upper wall surface of the fluid case forms an apex adjacent the slope ceiling having a cross-sectional width orthogonal to the longitudinal axis narrower than the given wide cross-sectional width of the base.

15. The measurement apparatus of claim 1 further comprising means for interfacing the fluid case with the measuring surface.

16. The measurement apparatus of claim 15 wherein the interfacing means comprise a suction cup.

17. The measurement apparatus of claim 15 wherein the interfacing means further comprise a level.

18. A method for measuring the slope of a surface, the method comprising:
providing a measurement apparatus for measuring the slope of a surface, the apparatus comprising:
a fluid case having a wall forming a closed container, the fluid case having an upper wall surface, a lower wall surface, a first end, a second end, and a longitudinal axis from the first end to the second end of the fluid case;
a fluid contained within the fluid case, the fluid having a given density;
an indicator contained within the fluid case, the indicator having a density less than the given density of the fluid;
calibrated markings on the fluid case corresponding to the indicator at the positioned slope of the measurement apparatus; and
a sloped ceiling formed in the upper wall surface along the longitudinal axis of the fluid case, a first portion of the ceiling having no slope relative to a flat reference surface, the first portion corresponding to a zero-point of the calibrated markings, and a second portion of the ceiling between the first portion and the first end, the second portion having a constant slope, downwardly, toward the first end;
placing the measurement apparatus on the surface; and
reading the calibrated markings corresponding with the indicator for measuring the slope of the surface.

19. The method of claim 18, further comprising the method step of providing a second measurement apparatus for measuring the slope of a surface.

20. The measurement apparatus of claim 1 further comprising a second fluid case.

21. The measurement apparatus of claim 20 wherein the calibrated markings of the fluid case are percentage of elevation and the calibrated marking of the second fluid case are percentage of elevation.

22. The measurement apparatus of claim 21 wherein the percentage of elevation calibrated markings of the fluid case are drawn to a first scale and the percentage of elevation calibrated markings of the second fluid case are drawn to a second scale.

23. The measurement apparatus of claim 20 wherein the calibrated markings of the fluid case are degree of inclination and the calibrated markings of the second fluid case are degree of inclination.

24. The measurement apparatus of claim 23 wherein the calibrated markings for degree of inclination of the fluid case are drawn to a first scale and the calibrated markings for degree of inclination of the second fluid case are drawn to a second scale.

25. The measurement apparatus of claim 20 wherein the calibrated markings of the fluid case are percentage of elevation and the calibrated markings of the second fluid case are degree of inclination.

26. A kit for mounting a measurement apparatus for measuring the slope of a surface to an existing level, the kit comprising:
a measurement apparatus for measuring the slope of a surface, the apparatus comprising:
a fluid case having a wall forming a closed container, the fluid case having an upper wall surface, a lower wall surface, a first end, a second end, and a longitudinal axis from the first end to the second end of the fluid case;
a fluid contained within the fluid case, the fluid having a given density;
an indicator contained within the fluid case, the indicator having a density less than the given density of the fluid;
calibrated markings on the fluid case corresponding to the indicator at the positioned slope of the measurement apparatus; and
a sloped ceiling formed in the upper wall surface along the longitudinal axis of the fluid case, a first portion of the ceiling having no slope relative to a flat reference surface, the first portion corresponding to a zero-point of the calibrated markings, and a second portion of the ceiling between the first portion and the first end, the second portion having a constant slope, downwardly, toward the first end; and
means for attaching the measurement apparatus to the existing level.

27. The kit of claim 26 further comprising a second measurement apparatus.

28. The kit of claim 27 wherein the measurement apparatus and the second measurement apparatus have a first scale and a second scale, respectively.

29. The kit of claim 27 wherein the calibrated markings of the measurement apparatus are percentage of elevation and the calibrated markings of the second measurement apparatus are degrees of inclination.
